(19) United States
(12) Patent Application Publication
(10) Pub. No.: US 2025/0251489 A1
(43) Pub. Date: Aug. 7, 2025

(54) Housing Structure for a Radar Device of a Vehicle and Radar Device for a Vehicle

(71) Applicant: Illinois Tool Works Inc., Glenview, IL (US)

(72) Inventors: Salvatore Cicero, Oberthulba (DE); Eyüp Aslan, Hannover (DE); Fredrik Andersson, Västeräs (SE); Marian Cristea, City Ghimbav (RO)

(21) Appl. No.: 19/013,867

(22) Filed: Jan. 8, 2025

(30) Foreign Application Priority Data
Feb. 1, 2024 (DE) 10 2024 102 860.2

(51) Int. Cl. G01S 7/02; G01S 7/03

(52) U.S. Cl. CPC G01S 7/028; G01S 7/03

(57) ABSTRACT

The disclosure relates to a housing structure (1) for a radar apparatus of a vehicle. The housing structure (1) includes a radiation window (2) formed at least partially or regionally from a plastic material. A material permittivity and a dielectric constant of the plastic material of the radiation window (2) are selected such that electromagnetic waves transmitted from and/or received by the radar apparatus can pass through the radiation window (2) at least nearly undamped, and in particular with a damping of max. 6 dB in a single pass. The housing structure (1) includes a frame region (3) surrounding the radiation window (2), in which a heating apparatus (4) is integrated, wherein fillers are embedded in the plastic material of the radiation window (2), which increase a thermal conductivity of the plastic material of the radiation window (2).

### RELATED APPLICATION

The present application claims the benefit of German Patent Application No. 10 2024 102 860.2, filed Feb. 1, 2024, titled “Housing Structure for a Radar Device of a Vehicle and Radar Device for a Vehicle,” the contents of which are hereby incorporated by reference.

### BACKGROUND

When driving, whether manually or automatically, a vehicle should or must always (in the case of autonomous driving) be able to reliably detect and react to objects and people. A corresponding radar apparatus, which is in particular configured as a front radar apparatus, allows precise, fast, and robust object detection and object tracking due to high range, wide opening angle, high angle separability, and optionally its own chirp sequence modulation, so that the radar apparatus is particularly suitable for complex traffic situations.

Radar apparatuses, in particular front radar apparatuses, are typically exposed to the effects of weather conditions, such as snow, ice, or rain/wet, which affects object image resolution of radar signals. Furthermore, weather-related effects on the radar signal characteristic are known, which, in the context of a downstream dynamic image analysis, can lead to incorrect information regarding the travel horizon/sampling field, such that, for example, in the case of freezing rain, weather conditions are present that adversely affect radar sensory detection and thus object detection, although the weather conditions make the reliability in the vehicle necessary.

In particular, it must be ensured that the radiation window of the housing of the radar apparatus, through which electromagnetic waves transmitted from and/or received by the radar apparatus, is as fully freed of moisture and ice as possible.

For this purpose, for example, it is known from the publication DE 10 2013 214 286A1 to direct warm air that serves for defrosting or de-icing the radiation window of a radar sensor to an edge region of the radiation window via an air exhalation nozzle connected to the vehicle's air conditioning system via an air outlet hose.

Such an approach to defrosting and/or de-icing the radiation window of a radar sensor results in relatively high additional manufacturing and assembly costs. In addition, the vehicle must be configured accordingly, so that the additional air outlet hose, which also requires an additional design space, can be accommodated.

Despite advancements to date, a need exists for an improved radar apparatus for a vehicle.

### SUMMARY

The present disclosure relates generally to a radar apparatus for a vehicle, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a plan view of the radiation window, an exemplary embodiment of the housing structure according to the disclosure.

FIG. 2 illustrates schematically, a sectional view along the line A-A in FIG. 1.

FIG. 3 illustrates schematically, an exploded view of the individual components of the exemplary embodiment of the housing structure according to the disclosure according to FIG. 1.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The word “radar” is an abbreviation and refers to radio detection and distance measurement.

The present disclosure relates to a radar apparatus for a vehicle, comprising at least one antenna element and a housing structure having a radiation window, wherein the radiation window is configured to allow passage of electromagnetic waves transmitted from and/or received by the radar apparatus.

The radar apparatus is in particular a front radar sensor as part of a driver assistance system for implementing driving functions for greater comfort, safety, and automated driving. Generally, a radar apparatus on a vehicle serves as a detection system to determine a distance, angle, or speed of an object in the vicinity of the vehicle with respect to the radar apparatus. The radar apparatus typically comprises at least one transmitter generating electromagnetic waves in the radiowave or microwave range, at least one transmitter antenna, at least one receiver antenna, a receiver, and a processor. Radiowaves transmitted by the radar apparatus are reflected by the object in the environment of the vehicle. The return signal, i.e., the reflected radio waves, is received by the radar apparatus and provides information about the location and the speed of the object.

A further problem to consider when using radar apparatuses in vehicles can be seen in that, in a relatively warm environment, such as occurs during high summer, the temperature within the housing of the radar apparatus can rise significantly, which also negatively impacts the achievable object detection and object identification in a travel horizon.

In order to avoid excessive heating, in particular of the electronic components of the radar apparatus, it is known to provide corresponding ventilation openings in the housing of the radar apparatus, so that air flow can circulate through the housing in order to thus counteract excessive heating of the housing.

However, the provision of such ventilation openings in the housing has the disadvantage that dirt particles and/or moisture can also enter the housing through the ventilation openings, which in turn negatively influences the operational capability of the radar apparatus.

Based on this problem, the problem addressed by the disclosure is thus to specify a solution in which the radiation window of the housing structure of a radar apparatus can be reliably defrosted and/or defrosted in an easily realized yet effective manner, while simultaneously ensuring cooling in summer operation without dirt or moisture entering the interior of the housing structure of the radar apparatus.

Accordingly, the disclosure relates in particular to a housing structure for a radar apparatus of a vehicle, wherein the housing structure comprises a radiation window formed at least partially or regionally from a plastic material.

The housing structure in particular forms a cover element, which is configured to allow passage of electromagnetic waves transmitted and/or received by at least one antenna (receiving antenna and/or transmitter antenna) of the radar apparatus through the radiation window. Therefore, at least the radiation window of the housing structure is at least substantially invisible to the electromagnetic waves transmitted from and/or received by the radar apparatus.

The housing structure, and in particular the region of the housing structure in which the radiation window is formed, is typically arranged upstream of the antennas of the radar apparatus, so that this region can be referred to as a radar dome or radome.

In particular, a material permittivity and dielectric constant of the plastic material of the radiation window are selected such that electromagnetic waves transmitted and/or accommodated from the radar apparatus can preferably pass through the radiation window at least nearly undamped.

In this context, “nearly undamped” means in particular that the electromagnetic waves transmitted from and/or received by the radar apparatus can pass through the radiation window with a damping of max. 6 dB in a single pass.

In addition to the radiation window, the housing structure comprises further parts, which are in particular also made of plastic, although it is also conceivable that the further parts of the housing structure are made of another material, for example metal. In particular, the housing structure comprises a frame region surrounding the radiation window, in which a heating apparatus is integrated.

The heating apparatus is in particular an electrically operated or operable heating apparatus.

In order for the thermal energy output as needed by the heating apparatus to be successfully transported at least partially or regionally, and in particular over as large a surface area as possible, to the radiation window of the housing structure, it is provided in particular that fillers increasing the thermal conductivity of the plastic material are embedded in the plastic material of the radiation window.

In this regard, a dielectric constant of the fillers embedded in the plastic material of the radiation window, which improve/increase the thermal conductivity of the plastic material of the radiation window, is selected such that the fillers are at least substantially transparent to electromagnetic waves transmitted from and/or received by the radar apparatus.

Fillers made of boron nitride, in particular hexagonal boron nitride, fillers made of magnesium oxide, fillers made of aluminum oxide, fillers made of aluminum nitride, fillers made of aluminosilicate, and/or fillers of zinc sulfite have proven to be particularly suitable fillers for embedding in the plastic material of the radiation window.

The aforementioned fillers are characterized by the fact that they are electrically insulating and have a high thermal conductivity. The electrical resistance of the fillers is in a range between 1011 to 1020Ω×m, while the thermal conductivity is between 14 to 400 Watt/mK. Of course, other suitable electrically insulating fillers are also possible.

According to implementations of the housing structure according to the disclosure, it is provided that the heating apparatus integrated in the frame region surrounding the radiation window comprises a strip conductor assembly preferably fully integrated in the material of the frame region, which is configured such that, when an electrical voltage is applied and/or an electrical current is supplied, at least the frame region of the housing structure is heated at least regionally due to a power dissipation as a function of the (ohmic) resistance of the strip conductor assembly.

In a particularly easy to realize, yet effective manner, the strip conductor assembly can be formed by means of a printing process, in particular using electrically conductive ink. It is also expedient that the strip conductor assembly comprises at least one strip conductor formed in a printing process, in particular a silver printing process.

Alternatively, however, it is also conceivable that the heating apparatus, which is integrated in the frame region surrounding the radiation window, is also formed by electrically conductive fillers which are embedded in the material, in particular the plastic material, of the frame region at least regionally. Copper, aluminum, iron, silver, and/or graphite particles are expedient as suitable fillers. Alternatively, or additionally, fillers made of carbon black and/or CNT (carbon nanotubes) can also be used.

The configuration of such a heating apparatus in the frame region surrounding the radiation window has the advantage that the entire housing structure can be manufactured in an injection-molding process.

In particular, the electrically conductive fillers are at least regionally embedded into the material, in particular the plastic material, of the frame region of the housing structure in such a way that, when an electrical voltage is applied and/or when an electrical current is supplied to the region in which the electrically conductive fillers are embedded, at least the frame region of the housing structure is heated at least regionally due to a power dissipation as a function of the electric resistance of the region.

It is particularly preferred that, at least in one region of the frame region, fillers are embedded in the material, in particular the plastic material, of the frame region, which increases the thermal conductivity of the material/plastic material.

These fillers are preferably also fillers made of boron nitride, in particular hexagonal boron nitride, magnesium oxide, aluminum oxide, aluminum nitride, aluminosilicate and/or zinc sulfite, wherein other fillers are also generally conceivable.

It is preferably provided in this context that the region of the frame region of the housing structure in which fillers increasing the thermal conductivity of the material are embedded in the material of the frame region is thermally conductively connected to the radiation window of the housing structure.

For example, it is contemplated and preferred that the region of the frame region of the housing structure in which fillers increasing the thermal conductivity of the material are embedded in the material of the frame region is integrally formed with the radiation window.

These design variants have the decisive advantage that the thermal energy emitted by the heating apparatus can reach the radiation window particularly well in a thermally conductive manner.

On the other hand, with fillers increasing the thermal conductivity of the material of the frame region of the housing structure, a passive cooling of the radiation window is brought about, for example in the summer, because thermal energy is transported (away) from the radiation window to the frame region of the housing structure, which results in a cooling of the radar apparatus at least partially or regionally accommodated by the housing structure.

Preferably, the frame region of the housing structure, and in particular a region of the frame region of the housing structure in which the heating apparatus is integrated, is completely over molded with a plastic material, in particular in an injection-molding process, in order to thus achieve an encapsulation of the heating apparatus, which provides particularly efficient protection against weathering effects.

According to implementations of the housing structure according to the disclosure, it is provided that the housing structure is manufactured in a plastic injection-molding process as a multi-layered and in particular triple-layered body, wherein the multi-layered body comprises an outer layer made of at least substantially radar-transparent plastic material, in which fillers increasing the thermal conductivity of the plastic material are embedded at least regionally.

In addition to the outer layer, a middle layer is used, which is also made of a plastic material, wherein the heating apparatus is formed at least regionally in the middle layer.

Finally, an inner layer of a plastic material is optionally provided, which covers the middle layer, and in particular the heating apparatus, thus causing an encapsulation of the heating apparatus.

The aforementioned layers of the body of the housing structure are preferably formed three-dimensionally.

In principle, it is contemplated that the plastic material of the outer layer is identical or at least substantially identical to the plastic material of the middle and/or inner layer.

To supply the electrical energy to the preferably fully encapsulated heating apparatus, the housing structure preferably comprises an electrical port that is guided through the inner layer.

The disclosure further relates to an assembly for temperature control of a radar sensor in a vehicle, in particular for as-needed defrosting and/or deicing, and for as-needed cooling of a radar sensor.

The assembly comprises at least one radar sensor and a housing associated with the at least one radar sensor, in which housing the at least one radar sensor is at least partially or regionally accommodated,

In this context in particular, it is provided that the housing associated with the at least one radar sensor is at least partially or regionally formed by a housing structure of the aforementioned type according to the disclosure.

In this context, it is expedient that the at least one radar sensor of the assembly is preferably accommodated in the housing in a fully encapsulated manner.

Finally, the disclosure relates to a radar apparatus for a vehicle, wherein the radar apparatus comprises at least one antenna element and a housing structure of the aforementioned type according to the disclosure. The radiation window of the housing structure is designed to allow passage of electromagnetic waves emitted from or received by the at least one radar apparatus through the radiation window, wherein the at least one antenna element is arranged to be adjacent to the radiation window.

The disclosure is described in greater detail in the following on the basis of an exemplary embodiment with reference to the accompanying drawings.

The exemplary embodiment of the housing structure 1 according to the disclosure as shown in the drawings is a housing structure 1 for a radar apparatus of a vehicle (not shown in the drawings).

On the one hand, the housing structure 1 serves to protect the radar apparatus and in particular at least one antenna element of the radar apparatus against the entry of dust and water.

On the other hand, the housing structure 1 provides active and passive temperature control of the radar apparatus or a radar sensor accommodated by the housing structure 1.

Active temperature control is carried out by a heating apparatus 4 integrated in the housing structure 1, while passive cooling of the radar sensor accommodated by the housing structure 1 is achieved due to the optimized thermal conductivity of the housing structure 1.

The housing structure 1 comprises a radiation window 2 formed at least partially or regionally from a plastic material, wherein a material permittivity and a dielectric constant of the plastic material of the radiation window 2 are each in a range that are typical for radar uses. Thus, the material of the radiation window 2 is invisible to the electromagnetic waves of the radar apparatus.

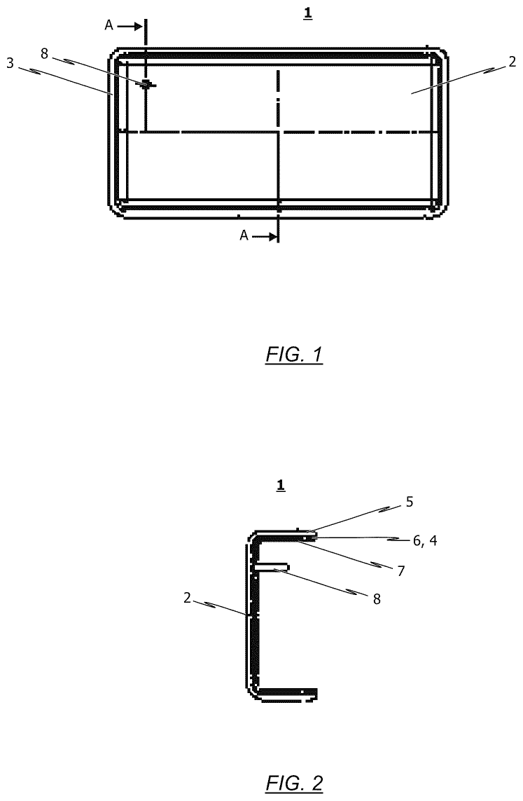

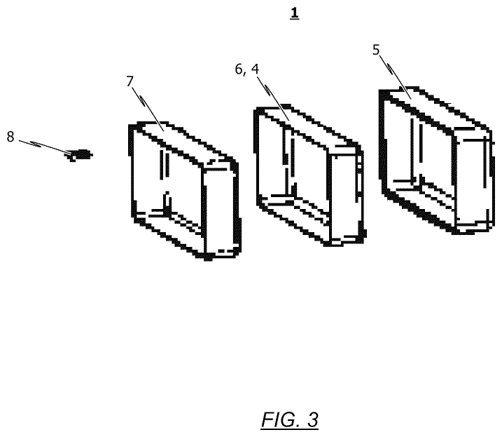

As can be seen in particular from the sectional view in FIG. 2, the housing structure 1 comprises a frame region 3 surrounding the radiation window 2, in which a heating apparatus 4 is integrated.

In particular, fillers are embedded in the plastic material of the radiation window 2, which increases a thermal conductivity of the plastic material of the radiation window 2.

These fillers, which increase the thermal conductivity of the plastic material, are preferably boron nitride.

Although not shown in the drawings, it is contemplated that the heating apparatus 4 integrated in the frame region 3 surrounding the radiation window 2 of the housing structure 1 comprises a strip conductor assembly preferably fully integrated in the material of the frame region 3, which is configured such that, when an electrical voltage is applied and/or an electrical current is supplied, at least the frame region 3 of the housing structure 1 is heated at least regionally, namely due to a power dissipation as a function of the ohmic resistance of the strip conductor assembly.

In this context, it is contemplated in particular that the strip conductor assembly comprises corresponding strip conductors formed in a printing process, in particular a silver printing process.

Alternatively, the heating apparatus 4, which is integrated in the frame region 3 surrounding the radiation window 2, can also be formed by electrically conductive fillers which are embedded in the material, in particular the plastic material, of the frame region 3 of the housing structure 1 at least regionally.

The electrically conductive fillers are, for example, copper, aluminum, iron, or graphite particles, and/or carbon black particles and/or CNT (carbon nanotubes).

In this configuration, the electrically conductive fillers should be at least regionally embedded into the material, in particular the plastic material, of the frame region 3 of the housing structure 1 in such a way that, when an electrical voltage is applied and/or when an electrical current is supplied to the region in which the electrically conductive fillers are embedded, at least the frame region 3 of the housing structure 1 is heated at least regionally due to a power dissipation as a function of the electric resistance of the region.

In the exemplary embodiment of the housing structure 1 according to the disclosure as shown in the drawings, it is also provided that, at least in a region of the frame region 3 of the housing structure 1, fillers are embedded in the material, in particular the plastic material, of the frame region 3, which increases the thermal conductivity of the material.

It is provided that the region of the frame region 3 of the housing structure 1 in which fillers increasing the thermal conductivity of the material are embedded in the material of the frame region 3 is thermally conductively connected to the radiation window 2 of the housing structure 1.

The exemplary embodiment of the housing structure 1 according to the disclosure is preferably formed entirely from a plastic material, as part of an injection-molding process.

Referring to the illustration in FIG. 3, it is noted that the exemplary embodiment of the housing structure 1 according to the disclosure comprises a three-dimensional outer layer 5 made of at least substantially radar-transparent plastic material in which, at least regionally, the fillers that increase the thermal conductivity are embedded.

The housing structure 1 further comprises a middle layer 6, in particular a three-dimensional layer, made of a plastic material, wherein the heating apparatus 4 is configured at least regionally in the middle layer 6.

Furthermore, the housing structure 1 comprises an inner layer 7 made of a plastic material, in particular a three-dimensional inner layer 7 made of a plastic material, which covers the middle layer 6 and in particular the heating apparatus 4.

It can further be seen from the exploded view in FIG. 3 that the housing structure 1 comprises an electrical port 8, which is guided through the inner layer 7 and serves to supply electrical energy to the heating apparatus 4 integrated in the middle layer 6.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Housing structure
2 Radiation window
3 Frame region
4 Heating apparatus
5 Outer layer
6 Middle layer
7 Inner layer
8 Electrical port

What is claimed is:

1. A housing structure (1) for a radar apparatus of a vehicle, the housing structure (1) comprising:
a radiation window (2) formed at least partially or regionally from a plastic material,
wherein a material permittivity and a dielectric constant of the plastic material of the radiation window (2) are selected such that electromagnetic waves transmitted from and/or received by the radar apparatus can pass through the radiation window (2) with a damping of max. 6 dB in a single pass,
wherein the housing structure (1) comprises a frame region (3) surrounding the radiation window (2), in which a heating apparatus (4) is integrated, and
wherein fillers are embedded in the plastic material of the radiation window (2), which increases a thermal conductivity of the plastic material of the radiation window (2).

2. The housing structure (1) according to claim 1,
wherein a dielectric constant of the fillers embedded in the plastic material of the radiation window (2) is selected such that the fillers are at least substantially transparent to electromagnetic waves transmitted from and/or received by the radar apparatus.

3. The housing structure (1) according to claim 1,
wherein the fillers embedded in the plastic material of the radiation window (2) comprises at least one of hexagonal boron nitride, magnesium oxide, aluminum oxide, aluminum nitride, aluminosilicate, and zinc sulfite.

4. The housing structure (1) according to claim 1,
wherein the heating apparatus (4) integrated in the frame region (3) surrounding the radiation window (2) comprises a strip conductor assembly fully integrated in the material of the frame region (3), which is configured such that, when an electrical voltage is applied and/or an electrical current is supplied, at least the frame region (3) of the housing structure (1) is heated at least regionally due to a power dissipation as a function of an ohmic resistance of the strip conductor assembly.

5. The housing structure (1) according to claim 4,
wherein the strip conductor assembly comprises at least one strip conductor formed in a silver printing process.

6. The housing structure (1) according to claim 1,
wherein the heating apparatus (4) integrated in the frame region (3) surrounding the radiation window (2) is formed by electrically conductive filler embedded at least regionally in the plastic material of the frame region (3), and
wherein the electrically conductive filler comprises at least one of copper, aluminum, iron, silver, graphite, carbon black, and/or carbon nanotubes (CNT).

7. The housing structure (1) according to claim 6,
wherein the electrically conductive fillers are at least regionally embedded into the plastic material of the frame region (3) in such a way that, when an electrical voltage is applied and/or when an electrical current is supplied to the region in which the electrically conductive fillers are embedded, at least the frame region (3) of the housing structure (1) is heated at least regionally due to a power dissipation as a function of an ohmic resistance of the region.

8. The housing structure (1) according to claim 1,
wherein, at least in a region of the frame region (3) of the housing structure (1), fillers are embedded into the plastic material of the frame region (3), which increases a thermal conductivity of the plastic material of the frame region (3),
wherein the fillers embedded into the plastic material of the frame region (3) comprises at least one of boron nitride, hexagonal boron nitride, magnesium oxide, aluminum oxide, aluminum nitride, aluminosilicate, and zinc sulfite.

9. The housing structure (1) according to claim 8,
wherein the region of the frame region (3) of the housing structure (1) in which fillers increasing the thermal conductivity of the material are embedded in the material of the frame region (3) is thermally conductively connected to the radiation window (2).

10. The housing structure (1) according to claim 8,
wherein the region of the frame region (3) of the housing structure (1) in which fillers increasing the thermal conductivity of the material are embedded in the material of the frame region (3) is integrally formed with the radiation window (2).

11. The housing structure (1) according to claim 1,
wherein a region of the frame region (3) of the housing structure (1) in which the heating apparatus (4) is integrated is entirely over molded with a plastic material as part of an injection-molding process.

12. The housing structure (1) according to claim 1,
wherein the housing structure (1) is configured as a triple-layer body produced in a plastic injection-molding process,
wherein the triple-layer body comprising:
an outer layer (5) made of an at least substantially radar-transparent plastic material, in which the fillers increasing the thermal conductivity are at least regionally embedded;
a middle layer (6) made of a plastic material, wherein the heating apparatus (4) is configured at least regionally in the middle layer; and
an inner layer (7) made of a plastic material, which covers the middle layer (6) and the heating apparatus (4).

13. The housing structure (1) according to claim 12,
wherein the plastic material of the outer layer (5) is substantially identical to the plastic material of the middle and/or inner layer (6, 7).

14. The housing structure (1) according to claim 12,
wherein the housing structure (1) comprises an electrical port (8), which is guided through the inner layer (7) and configured to supply electrical energy to the heating apparatus (4).

15. An assembly for temperature control of a radar sensor in a vehicle, the assembly comprising:
at least one radar sensor; and
a housing associated with the at least one radar sensor, in which housing the at least one radar sensor is at least partially or regionally accommodated,
wherein the housing associated with the at least one radar sensor is at least partially or regionally formed by a housing structure (1) according to claim 1.

16. The assembly according to claim 15,
wherein the at least one radar sensor is accommodated in the housing in a fully encapsulated manner.

17. A radar apparatus for a vehicle, wherein the radar apparatus comprises at least one antenna element and a housing structure (1) according to claim 1, wherein the radiation window (2) of the housing structure (1) is configured to allow passage of electromagnetic waves transmitted from and/or received by the at least one antenna element through the radiation window (2), wherein the at least one antenna element is arranged to be adjacent to the radiation window (2).
